(19) United States
(12) Patent Application Publication
(10) Pub. No.: US 2008/0007407 A1
(43) Pub. Date: Jan. 10, 2008

(54) Zone supervision system

(76) Inventor: Maximo M. de Elia, Huntington, NY (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/481,115

(22) Filed: Jul. 5, 2006

(51) Int. Cl. G08B 13/14; G08B 23/00

(52) U.S. Cl. 340/572.1; 340/573.4

(57) ABSTRACT

A zone supervision system having supervisory override is disclosed. The zone supervision system includes a first tag worn by an individual to be supervised, a second tag worn by a supervisor, one or more monitoring units capable of detecting the first and second tags, and an alarm mechanism operably connected to the monitoring units for alerting supervision when the presence of the first tag and the absences of the second tag is detected in the restricted zone. The monitoring units operate to form a supervisory zone which includes a safe zone and a restricted zone. The system may further include a central monitoring station operably connected to the monitoring units. The central monitoring station may be connected to the monitoring units via cable, WIFI, LAN, WAN, RF or microwave. The central monitoring station may further be connected to a remote monitoring station. The alarm mechanism of the zone supervision system may include a siren.

### BACKGROUND

1. Technical Field

The present disclosure relates to systems for providing zone supervision. More particularly, the present disclosure relates to zone supervision systems having a supervisory override.

2. Background of Related Art

Supervision systems for the monitoring and supervising of moving objects, and in particular for supervising persons, are known in the art. Such systems may be employed in a wide range of applications in a variety of fields, including security, law enforcement, and medicine. Supervision systems may allow for decreased restrictions of the monitored person, decreased supervisory man-power, discreetness, easy installation, mobility and multipurpose operation.

A typical supervision system comprises one or more portable transmitting devices, known as “tags”, affixed to a supervised individual and at least one monitoring unit for detecting the tags and alerting the supervisor when a predetermined condition is met. The one or more monitoring units may operate to monitor a designated area, or “zone”, wherein any tag within the zone may be located and identified. Depending on the system, the one or more monitoring systems may also receive information from the tag concerning the condition of the supervised individual. The one or more monitoring units may instead operate to form a boundary or perimeter defining the designated area. In this manner, the unit or units operate to detect a tag as it passes over the perimeter as the supervised individual enters and exits the designated zone. Alternate systems utilize a monitoring unit that alerts the supervisor when the supervised individual travels a predetermined distance from the local monitoring unit. In many instances the one or more local monitoring units operate in conjunction with a central monitoring station.

The local monitoring unit is a device designed to receive and send signals to and from a tag or a number of tags and, and possibly, to and from one or more central monitoring stations. The central monitoring station is typically a computer device for collecting and further processing the information received by the local monitoring unit or units. The identification of the various tags may be completed by the local monitoring unit or by the central monitoring station. The central monitoring station may operate to sound a bell or alarm to alert a supervisor when a local monitoring unit detects that a predetermined condition has been met and relays that information to the central monitoring station. The central monitoring station may also operate to lock doors, close entrances, raise barricades, alert additional personnel, disable equipment, etc.

The tag worn by a supervised individual is any device capable of being detected by a local monitoring unit. Typically, radio frequency identification (RFID) technology is implemented in the tags. The radio frequency (RF) signals are emitted from the tags and are detected by the local monitoring unit or units where each tag may be identified by a unique code or where the information is further relayed to the central monitoring station for further processing. The identification code may be a code unique to the particular subject. In this manner, that subject may be individually identified. Alternatively, the identification code may be a code typical to a certain group. For example, in a hospital, patients may wear a tag having a first identification code and staff may wear tags having a second identification code.

The local monitoring units include a RF or other signal receiving unit tuned to the frequency of the signals transmitted by the tags. Typically, the local monitoring unit further includes a microprocessor to allow local processing of the data before sending it to the central monitoring station. The communication between local monitoring units and a central monitoring station may be either wireless communication, such as RF, or by conventional communication lines such as telephone lines, cable TV, WAN, LAN and the like.

When used for monitoring persons, the portable tag is usually worn by the person being monitored and typically includes various sensors for sensing tampering with the tag and other activities of the supervised individual. The sensors may periodically or constantly transmit corresponding signals, including the tag identification code and the sensor's data. The signals are broadcasted either periodically or continuously, to be received by one or more local monitoring units, where they are processed and optionally reported to the central monitoring stations. Modern tags may include microprocessors which enable programming of the tag with regard to various parameters in order to meet the requirements specific to the supervised individual. Thus, parameters such as sampling intervals, data transmission intervals, monitored time periods, permitted and barred locations and a like, can be selected according to the specific needs of the situation. U.S. Pat. Nos. 5,504,474, 5,831,535, and 5,936,529, disclose tamper-resistant tags of the ilk used in supervision systems.

Numerous zone supervisions systems have been disclosed describing various applications of the above described systems. U.S. Pat. No. 5,751,214 granted to Cowley et al. on May 12, 1998 describes a device for monitoring the movement of a patient. In this system, multiple sensors are used to monitor the patient's movement. The sensors provide signals to a unit capable of activating an alarm to indicate the movement of the patient beyond a prescribed limit or to indicate other conditions. Information received from the sensors is stored in the alarm unit and then transferred to a remote computer for evaluation of the patient's care.

U.S. Pat. No. 6,054,928 granted to Lemelson et al. on Apr. 25, 2000 discloses a system wherein data relating to a prisoner is obtained by a sensor/processor unit worn by the prisoner to track the location of the prisoner and to monitor physical conditions of the prisoner. The sensors/processor unit communicates with a control center via radio links or through “home base” via a telephone link. A control center has an associated data storage and is used to collect the data and compare it with authorized activities and to learn about the behavior of the prisoner.

U.S. Patent Publication 2004/0085210 entitled “Personal Monitoring System,” discloses a system for the monitoring of persons, in particular of children and of adults requiring supervision. The system functions by sounding a siren when the transmitter and receiver exceed a predetermined distance from one another.

U.S. Pat. No. 7,012,534, issued Mar. 14, 2006, to Chaco, discloses an infant security system for monitoring an infant in a maternity ward setting. In this system infants and caretakers are fitted with RFID badges. Strategically placed monitoring devices are programmed to sound an alarm when it is determined that a responsible party is not within a predefined safe distance from an infant, whenever the infant is removed from the bassinet by a non-authorized party, and when the infant is removed from the bassinet by an authorized party beyond a preprogrammed safety zone.

Each of the above disclosed monitoring systems operate to monitor a patient, prisoner, child, etc. in a designated zone. The systems are designed to sound an alarm when a predetermined condition is met, namely, the introduction of an individual wearing a transmitter or tag into a restricted area or beyond a specified area or perimeter. In the above disclosed monitoring systems the presences of a supervisor or other responsible party in the restricted area with the supervised individual, or accompanying the individual beyond the specified perimeter, has no effect on the monitoring systems. In other words, the alarm will still sound when an individual enters the restricted area or passes beyond the specified perimeter, regardless of the presences of a supervisor or other responsible party. Nothing short of disabling the alarm will prevent the alarm from sounding, even in the presence of a supervisor.

Accordingly, a need exists for a zone supervision system with a supervisory override, such when a supervisor is present with the supervised individual entrance into a restricted zone does not sound an alarm.

### SUMMARY

According to an aspect of the present disclosure, zone supervision system having supervisory override is provided. The zone supervision system includes a first tag worn by an individual to be supervised, a second tag worn by a supervisor, one or more monitoring units capable of detecting the first and second tags, and an alarm mechanism operably connected to the one or more monitoring units for alerting supervision when the units have detected the presence of the first tag and the absences of the second tag in the restricted zone.

In one embodiment, the one or more monitoring units operate to form a supervisory zone which includes a safe zone and a restricted zone. The restricted zone may include a pool. The zone supervision system may further include a central monitoring station operably connected to the one or more monitoring units. The central monitoring station may be connected to the one ore more monitoring units via cable, WIFI, LAN, WAN, RF or microwave. The central monitoring station may further be connected to a remote monitoring station. The alarm mechanism of the zone supervision system may include a siren.

The first and second tags of the zone supervision system emit unique radio frequency signals. The first and/or second tag may be incorporated into a piece of clothing or accessory.

The tags may further include a tamper resistance mechanism. The tamper resistance mechanism may include a pulse monitor, conductivity sensor, temperature gauge, motion detector or moisture monitor. The tamper resistance mechanism is operably connected to the alarm mechanism for alerting supervision when the tag is removed.

An alternate embodiment of the zone supervision system having supervisory override include one or more monitoring units that define a supervisory zone having a restricted zone and a safe zone, a first tag emitting a first signal capable of being detected by the monitoring units, a second tag emitting a second signal capable of being detected by the monitoring units, and an alarm operably connected to the one or more monitoring units configured to activate when the first tag is detected by the monitoring units as being located in the restricted zone in the absence of the second tag. The alarm may be configured to silence when the second tag is detected by the monitoring units as being located in the restricted zone.

### BRIEF DESCRIPTION OF THE DRAWINGS

The foregoing objects and advantages of the present invention may be more readily understood by one skilled in the art with reference being had to the following detailed description of preferred embodiments thereof, taken in conjunction with the accompanying drawings in which:

FIG. 1 is a diagram of a zone supervision system of the present disclosure;

FIG. 2 is a diagram of the zone supervision system of FIG. 1;

FIG. 3 is a diagram of the zone supervision system of FIGS. 1-2;

FIG. 4 is a perspective view of a supervised tag for use in the zone supervision system of FIGS. 1-3; and

FIG. 5 is a perspective view of a supervisor tag for use in the zone supervision system of FIGS. 1-3.

### DETAILED DESCRIPTION OF PREFERRED EMBODIMENTS

Particular embodiments of the zone supervision system in accordance with the present disclosure will now be described in detail with reference to the drawing figures wherein like reference numerals identify similar or identical elements. While the zone supervision system of the present disclosure may be utilized in any number of applications where dangerous or potentially dangerous materials, structures or equipment may result in harm to individuals or property if not properly supervised, the system will be described herein as relates to the supervision of an area including a yard with a pool.

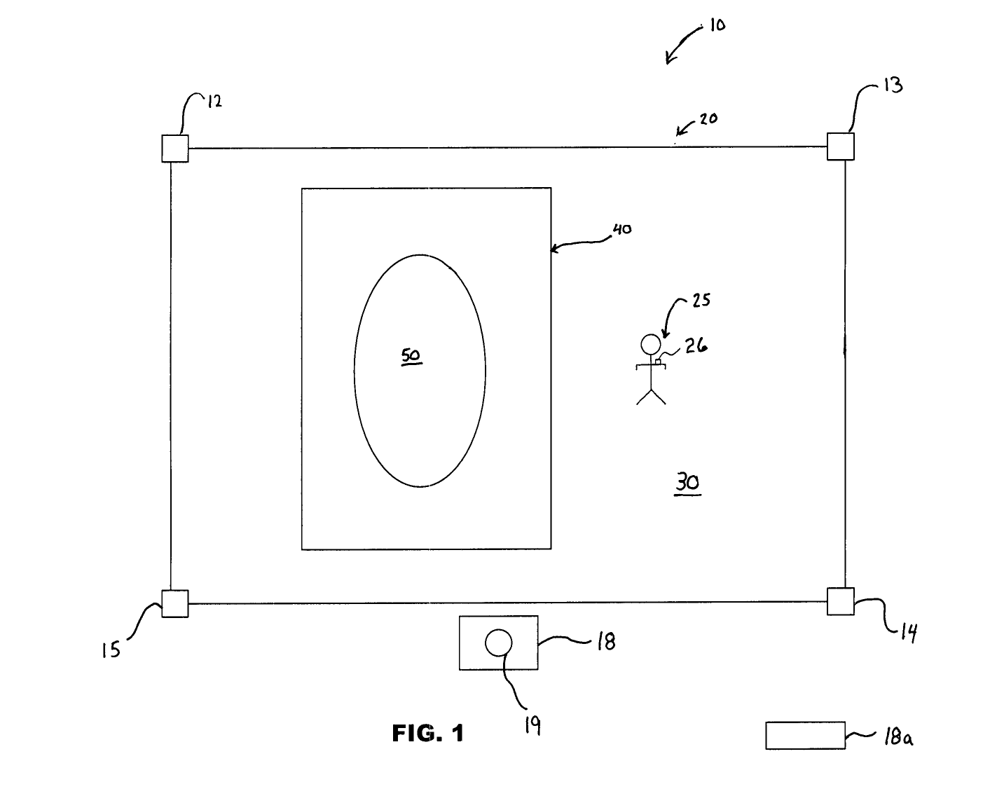

A zone supervisory system in accordance with the present disclosure is illustrate in FIGS. 1-3 and is generally designated as zone supervisory system 10. For purposes of this detailed description, the person or persons being monitored or supervised will be referred to as the “supervised” and shown generally as 25. The person or persons monitoring or responsible for supervising the supervised will be referred to as the “supervisor” and will be shown generally as 35.

The area monitored by zone supervision system 10 is hereinafter referred to as the “supervisory area” and is shown generally as 20. Supervisory area 20 includes a pool, hereinafter designated the “danger zone” and shown generally as 50, an area immediately adjacent the pool hereinafter designated the “restricted zone” and shown generally as 40, and an open area surrounding the restricted zone hereinafter designated the “safe zone” and shown generally as 30. The pool, designated danger zone 50, may be in-ground or above-ground and of any shape or size. Restricted zone 40 may define an area of predetermined distance from danger zone 50, thereby forming a boundary or apron around danger zone 50. Restricted zone 40 may vary in area and/or shape depending on any number of factors including the degree of hazard contained within danger zone 50 and the length of time required for supervision to respond to the scene. Restricted zone 40 may further include a deck or patio. The deck or patio may be situated level with the ground or may be elevated.

Referring to FIG. 1-3, local monitoring units 12,13,14,15 are positioned along the perimeter of supervisory area 20. In the present embodiment, supervisory area 20 defines a rectangular yard wherein local monitoring units 12-15 are positioned at the corners. Alternate configurations permit local monitor units 12-15 to be positioned anywhere in or about supervisory area 20. Positioning of local monitoring units 12-15 is not limited to the perimeter of the supervisory area 20 and may be located within supervisory area 20. Local monitoring units 12-15 may be incorporated into a fence or other landscaping element. Local monitoring units 12-15 may also be buried in the ground. More than four local monitoring units 12-15 may be required to adequately monitor larger areas.

As with other monitoring systems, local monitoring units 12-15 may be operably connected to a central monitoring station 18. Central monitoring station 18 may be connected to local monitoring units 12-15 with any known means, wired or wireless, including cable, WIFI, LAN, WAN, RF and microwave. Central monitoring station 18 may be located within the supervisory area or remotely. Central monitoring station 18 may be permanently affixed in a location so as to establish a base from where zone supervision system 10 may be monitored. Central monitoring station 18 may further be portable such that zone supervision system 10 can be monitored remotely. Central monitoring station 18 may further be connected to a second or alternate monitoring system 18a. Central monitoring station 18 includes at least one means for alerting supervisor 35 when a predetermined condition has be achieved, ie. an alarm or siren 19. Sounding of alarm 19 may not be the only action triggered when the absence of a supervisor is detected. It is envisioned that doors may be locked and/or protective barriers may be raised.

Initial installation of zone supervisory system 10 requires programming of central monitoring station 18 to establish supervisory area 20 and zones 30,40,50 therein. Once programmed, central monitoring station 18 may receive information from local monitoring units 12-15 to determine in which zones 30,40,50 of supervisory area 20 an identification tag is located. Local monitoring units 12-15 and/or central monitoring station 18 may rely on triangulation, global positioning satellite (GPS) or any other positioning means to establish the location of supervised 25 and/or supervisor 35 within supervisory area 20.

Supervised 25 and supervisor 35 are required to wear identification tags 26,36, respectively, such that their position can be detected by local monitoring units 12-15 and/or central monitoring station 18. Supervised 25 wears supervised identification tag or supervised tag 26 that identifies the wearer as being “supervised”. There may be more than one supervised 25 and thus a need for more than one supervised tag 26. Additional supervised tags 26 may further be coded to identify individuals among the “supervised”. As with supervised 25, supervisor 35 is also required to wear an identification tag. Supervisor identification tag or supervisor tag 36 identifies the wearer as being a “supervisor”. Again, additional supervisor tags 36 may be coded to identify individuals among the supervisors.

As discussed above, identification tags for use with monitoring systems are well known in the art. Most any modern identification tag of any technology capable of either emitting a signal or being detected by local monitoring units 12-15 have been contemplated for use with zone supervisory system 10. This includes the use of identification tags utilizing radio frequency, microwave, and the like. Identification tags 26,36 may be configured as bracelets, anklets, hair bands, necklaces, etc. or may be incorporated into the clothing of the wearer. Identification tags 26,36 may further include a tamper resistance or locking mechanism.

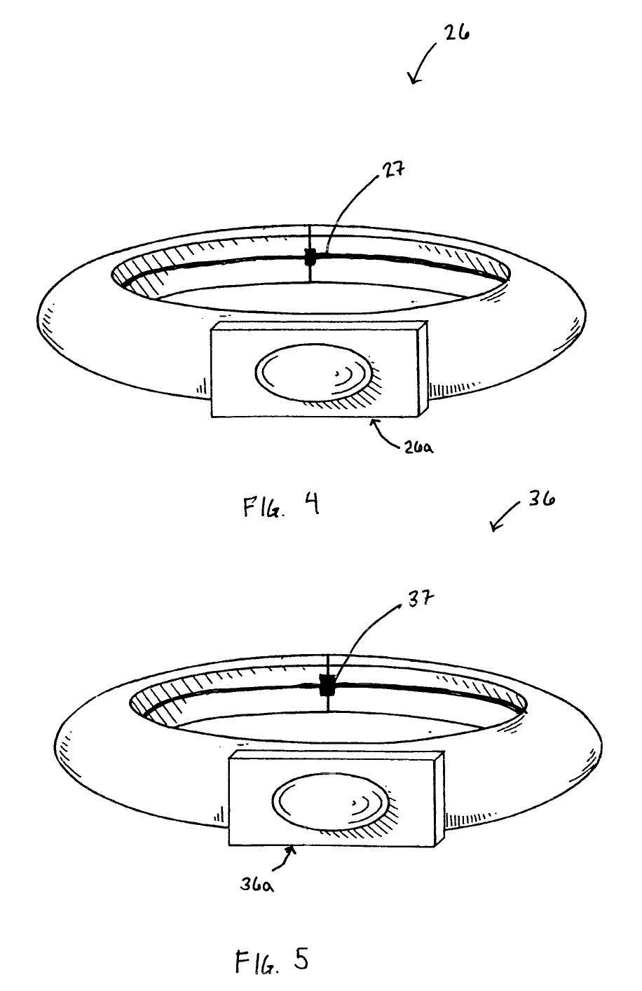

Referring now to FIGS. 4 and 5, tags 26,36 may include a sensor 26a,36a, respectively, capable of detecting when tags 26,36 have been removed by wearers 25,35. Tags 26,36 include a circuit 27,37, respectively, that is closed when once tags 26,36 are place on wearers 25,35. As long as sensors 26a,36a detect closed circuit 27,37 no alarm is sounded. If and when closed circuit 27,37 opens or brakes, sensors 26a,36a will detect open circuit 27,37 and may either sound an alarm included in sensors 26a,36a or send a signal to the one or more monitoring units 12-15. In an alternate embodiment, sensors 36a,37a may include a pulse monitor, conductivity sensor, temperature gauge, motion detector, moisture monitor or the like, for detecting when tags 26,36 are removed from wearers 25,35. Tags 36,37 may further be waterproof and/or heat resistant.

The operation of zone monitoring system 10 will now be described in detail with reference to FIGS. 1-3. Referring initially to FIG. 1, supervised 25, wearing supervised tag 26, is positioned within safe zone 30 of supervisory area 20. Local monitoring units 12-15, positioned at the corners of supervisor area 20 receive the signal emitted by, or detect the presences of, supervised tag 26 worn by supervised 25. The signal from supervised tag 26 is then relayed to central monitoring station 18 where it is determined that supervised 25 is outside restricted zone 40 or within safe zone 30. The determination that supervised 25 is outside restricted zone 40 may also be completed at local monitoring units 12-15. Because supervised 25 is positioned outside restricted zone 40 alarm 19 does not sound.

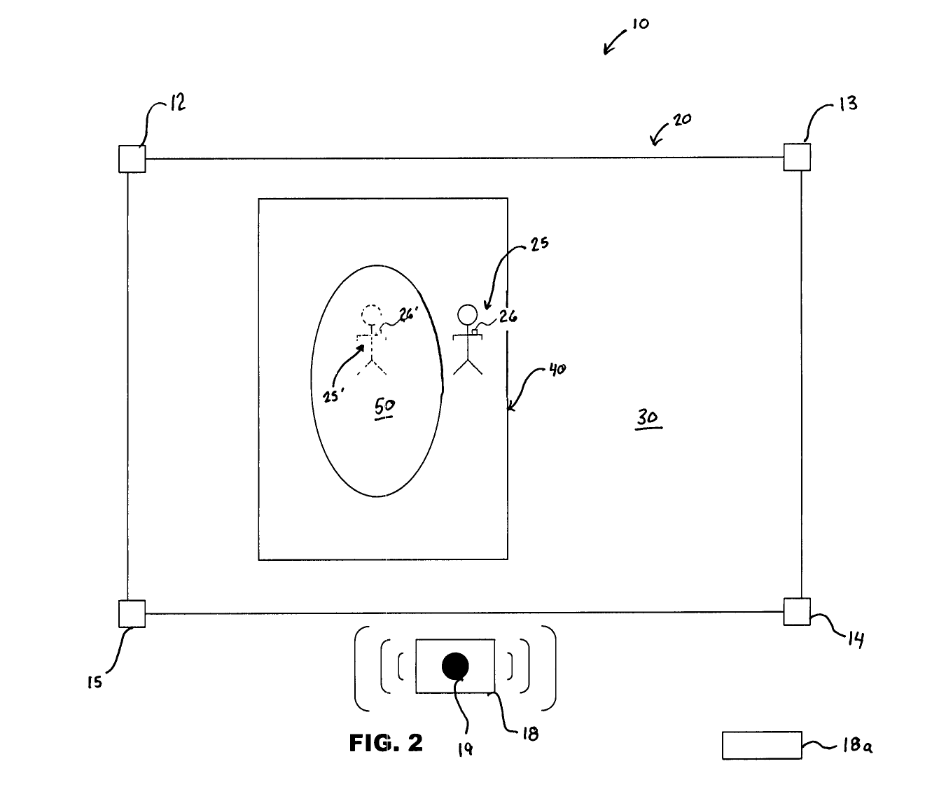

Referring now to FIG. 2, supervised 25 is shown within restricted zone 40. Upon entering restricted area 40, one or more local monitoring units 12-15, which had been continuously monitoring supervisory area 20, relayed to central monitoring station 18 the signal detected by local monitoring units 12-15 of supervised tag 26, where it is determined that supervised 25 had entered restricted area 40. Central monitoring station 18 further detects the absence of a signal from supervisor tag 36 worn by supervisor 35. As such, alarm 19 is sounded. Regardless of whether in restricted area 40 or danger zone 50, also shown in FIG. 2 (supervised 25′ wearing supervised tag 26′), if central monitoring station 18 detects the absence of supervisor 35 at least within restricted zone 40 alarm 19 will sound.

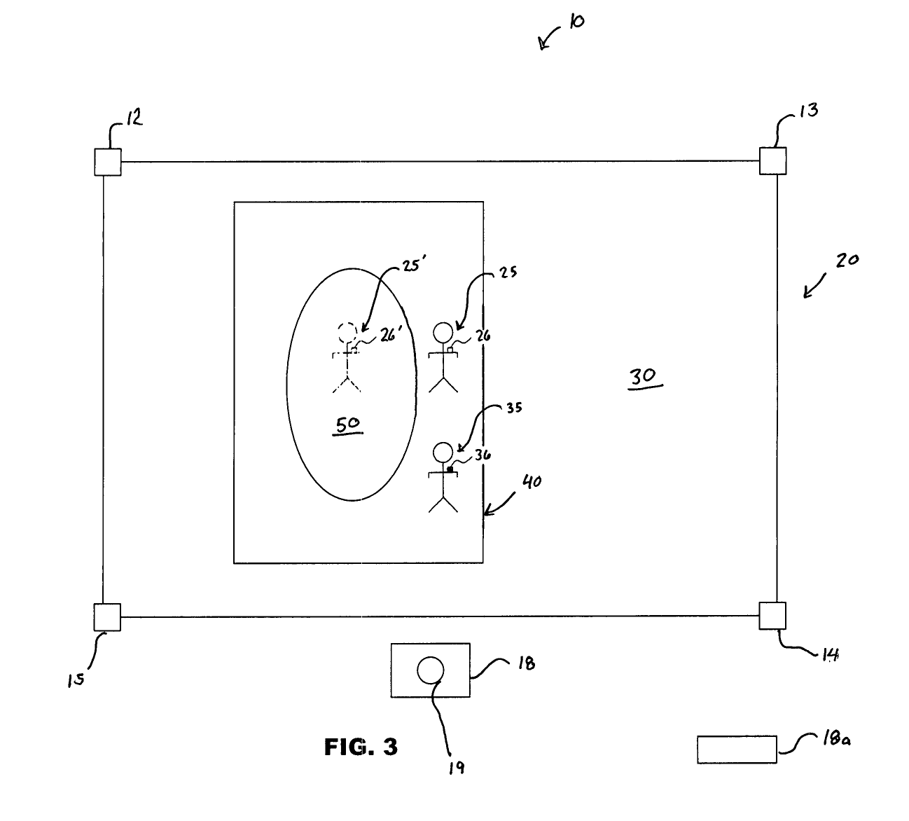

Referring now to FIG. 3, as in FIG. 2 supervised 25, wearing supervised tag 26, and supervisor 35 wearing supervisor tag 36 are shown within restricted area 40. Zone supervisory system 10, operating as before, does not sound an alarm upon the detection of supervised 25 within restricted area 40. The presence of supervisor 35 within restricted zone 40 along with supervised 25 overrides the sound of alarm 19 by central monitoring station 18. A similar result may be achieved when supervised 25′, wearing supervised tag 26′ is detected within danger zone 50, as long as supervisor 35 is detected within restricted zone 40. Central monitoring station 18 may be programmed to respond to any number of conditions or situations, including multiple supervised 25, multiple supervisors 35 and their relative positioning with each other among zones 20,30,40,50. Alarm 19 may also be triggered to sound when supervised 25 is detected leaving supervisory area 20.

Various delays and safeguards may be incorporated into zone supervisory system 10 to prevent false alarms or tampering and to ensure proper working of the system. To prevent access to supervisory area 20 without detection in the event identification tags 26,36 are not worn, zone supervisory system 10 may further be equipped with motion detectors, heat sensors, or the like capable of sounding alarm 19 when unauthorized personnel are detected within supervisory area 20.

Thus, it should be understood that various changes in form, detail and operation of the zone supervisory system of the present disclosure may be made without departing from the spirit of the present disclosure.

What I claim is:

1. A zone supervision system having supervisory override, the system comprising:
a first tag worn by an individual to be supervised;
a second tag worn by a supervisor;
one or more monitoring units capable of detecting the first and second tags; and
an alarm mechanism operably connected to the one or more monitoring units for alerting supervision when the one or more monitoring units detect the presence of the first tag and the absences of the second tag in the restricted zone.

2. A zone supervision system according to claim 1, wherein the one or more monitoring units operate to form a supervisory zone.

3. A zone supervision system according to claim 2, wherein the supervisory zone includes a safe zone and a restricted zone.

4. A zone supervision system according to claim 3, wherein the restricted zone includes a pool.

5. A zone supervision system according to claim 1, further including a central monitoring station operably connected to the one or more monitoring units.

6. A zone supervision system according to claim 5, wherein the central monitoring station is connected to the one ore more monitoring units via cable, WIFI, LAN, WAN, RF or microwave.

7. A zone supervision system according to claim 5, wherein the central monitoring station is further connected to a remote monitoring station.

8. A zone supervision system according to claim 1, wherein the alarm mechanism includes a siren.

9. A zone supervision system according to claim 1, wherein the first and second tags emit unique radio frequency signals.

10. A zone supervision system according to claim 1, wherein the first tag is incorporated into a piece of clothing or accessory.

11. A zone supervision system according to claim 1, wherein the second tag is incorporated into a piece of clothing or clothing accessory.

12. A zone supervision system according to claim 1, wherein the first tag includes a tamper resistance mechanism.

13. A zone supervision system according to claim 1, wherein the second tag includes a tamper resistance mechanism.

14. A zone supervision system according to claim 12, wherein the tamper resistance mechanism includes a pulse monitor, conductivity sensor, temperature gauge, motion detector or moisture monitor.

15. A zone supervision system according to claim 13, wherein the tamper resistance mechanism includes a pulse monitor, conductivity sensor, temperature gauge, motion detector or moisture monitor.

16. A zone supervision system according to claim 14, wherein the tamper resistance mechanism is operably connected to the alarm mechanism for alerting supervision when the tag is removed.

17. A zone supervision system according to claim 15, wherein the tamper resistance mechanism is operably connected to the alarm mechanism for alerting supervision when the tag is removed.

18. A zone supervision system having supervisory override, the system comprising:
one or more monitoring units defining a supervisory zone having a restricted zone and a safe zone;
a first tag emitting a first signal capable of being detected by the one or more monitoring units;
a second tag emitting a second signal capable of being detected by the one or more monitoring units; and
an alarm operably connected to the one or more monitoring units configured to activate when the first tag is detected by the one or more monitoring units as being located in the restricted zone in the absence of the second tag.

19. A zone supervision system according to claim 13, wherein the alarm is configured to silence when the second tag is detected by the one or more monitoring units as being located in the restricted zone.
